(19) United States
(12) Patent Application Publication
(10) Pub. No.: US 2017/0169525 A1
(43) Pub. Date: Jun. 15, 2017

(54) SYSTEMS TO ELECTRONICALLY CATALOG AND GENERATE DOCUMENTATION FOR RETAIL-LEVEL POWER

(71) Applicant: Open Access Technology International, Inc., Minneapolis, MN (US)

(72) Inventors: Sasan Mokhtari, Eden Prairie, MN (US); Ilya William Slutsker, Plymouth, MN (US); Behnam Danai, Cupertino, CA (US); Ali Ipakchi, San Carlos, CA (US); Farrokh Albuyeh, San Carlos, CA (US); Abdolhossein aka Farrokh Rahimi, Los Altos, CA (US)

(73) Assignee: Open Access Technology International, Inc., Minneapolis, MN (US)

(21) Appl. No.: 15/375,312

(22) Filed: Dec. 12, 2016

Related U.S. Application Data
(60) Provisional application No. 62/265,551, filed on Dec. 10, 2015.

(51) Int. Cl. G06Q 50/06; G06Q 10/06

(52) U.S. Cl. CPC G06Q 50/06; G06Q 10/06311

(57) ABSTRACT

Systems and methods are provided, which provide for a system for cataloging the discrete elements of retail power and use of the same for qualification and approval in order to utilize the data of registered and approved assets for scheduling distribution dispatch and implementing distribution dispatch. The inventive process facilitates the participation of any size distributed energy resource (DER) in power system operations, either alone or aggregated with any number of like resources or DER services now available to retail consumers, service providers, aggregators and the like.

### CROSS-REFERENCE TO RELATED APPLICATIONS

This application claims priority to U.S. Provisional patent application No. 62/265,551 filed Dec. 10, 2015, the entire content of which is hereby incorporated by reference.

### STATEMENT REGARDING FEDERALLY SPONSORED RESEARCH

Not Applicable.

### FIELD OF THE INVENTION

The present disclosure relates generally to systems and processes for cataloging/recording the discrete elements of retail power.

### BACKGROUND OF THE INVENTION

The electric industry is undergoing a paradigm shift due to a combination of factors including emergence of distributed energy resources (DER) such as distributed generation, customer-side electric and thermal storage, new communications, control and information technologies, increased demand-side participation, emphasis on increased use of renewable resources, and increased emphasis on grid resiliency.

The utility business model is also changing due to declining revenues resulting from increasing penetration of behind-the-meter (BTM) resources such as rooftop solar, energy conservation, and demand response (DR). Utilities need to offer new services to fill in the revenue gap. Moreover, the emphasis on customer choice, emergence of Curtailment Service Providers (CSFs), un-coordinated operation of customer-side distributed resources and BTM generation give rise to new operational problems for operators of the distribution system. To meet these challenges, the distribution utilities must adopt new operational processes, and need new operational tools.

The emerging Distribution System Operator (DSO) construct and its supporting Distribution System Platform (DSP) are intended to address these issues and in the process fill in a gap between distributed resources and bulk power operations to the mutual benefits of the prosumers, distribution utilities, and bulk power/market operators recognizing that the bulk power system reliability and market operation are also impacted by proliferation of DER and renewable resources.

The DSO/DSP would interface with the bulk power system operator (Balancing Authority, ISO/RTO) on the one hand, and with owners and/or operators of demand-side assets (e.g., Prosumers, Micro Grids, DR Aggregators, DER Aggregators, Energy Service Providers, etc.) on the other. A central function of the DSO/DSP which is facilitated by the invention in question is effective management of demand-side and distributed energy resources (DR/DER). To accomplish this, the invention provides the tools for the DSO to know both the location and operational behavior of DR/DER, contractual and/or tariff provisions associated with DR/DER operation, distribution system constraints, and interactions with bulk power operations. The invention will allow the DSO to manage the DR/DER based on conventional DR/DER tariffs (e.g., time of use, dynamic pricing, etc.), bi-lateral contracts between DR/DER owners, between DR/DER owners and the DSO, or through administration of a retail market as applicable.

This is reminiscent of issues and challenges that accompanied the creation of wholesale markets more than two decades ago in North America with Transmission Open Access. In the emerging paradigm of Distribution Open Access, to the extent allowed by regulatory provisions, retail consumers can choose their suppliers in a competitive environment, prosumers can engage in bilateral transactions, and the DSO must be aware of these transactions and accommodate them within the constraints of distribution system. There are two main differences with bulk power markets: (1) transacting agents may include not only human actors (Traders, Load Serving Entities, Generation Owners and Operators, Municipalities, Cooperatives, etc.), but also transactive devices; (2) analysis, approval, denial, and curtailment of DR/DER transactions must be accomplished in an automated environment at much higher rates than in current bulk power bilateral or centralized markets.

The invention provides mechanisms for the DSO/DSP to manage a large volume of transactions effectively, automatically, and in a timely manner, while providing for the system operators (DSOs, Balancing Areas, ISOs/RTOs) to gain visibility into the system conditions on demand, periodically, or upon submission of transactions, and adjust these transactions if/when warranted. In what follows, the central enabling mechanism provided for this purpose in this invention is referred to as D-tag for short.

### BRIEF SUMMARY OF THE INVENTION

In general, this disclosure is directed toward a system for cataloging the discrete elements of retail power and use of the same. The current invention provides an innovative way to construct and use a combination of informational elements, which is herein referred to as a “D-Tag,” in order to address business process needs as well as scale in a secure fashion, using a secured data center and, in some embodiments, encryption enabling software, in an automated fashion to accomplish large scale transactions. In some embodiments, the inventive process can facilitate tens of thousands of secure transactions per second within a DSO service area. The inventive process can be implemented in a cost efficient method, where the complexity of current transaction facilitating processes necessitate higher costs to utilize. The systems and methods are linked to and communicate with sources of input data, including but not necessarily limited to, asset owners, Demand Response (DR) and Distributed Energy Resources (DER), DER Service Providers, DSOs, Electric Utilities, Municipalities, Cooperatives, energy markets, service purchasers, Curtailment Service Providers (also known as Aggregators of Retail Customers; ARCs), and Microgrid Operators. In one particular embodiment, the invention relates to a system and method that allows the participation of any size DER in power system operations and facilitates offering, approving, scheduling, and implementing energy and ancillary service transactions by DERs, while facilitating actions to reduce adverse impacts on distribution reliability. This inventive process comprises registration, review and approval, scheduling and the implementation of energy acted out amongst a diverse group of stakeholders and system participants, including but not limited to, asset owners, prosumers, purchasing and selling entities, distribution wires operators/DSO, transmission balancing areas, and D-Tag service providers.

in one particular embodiment, the invention relates to a system and method that utilizes D-Tags for scheduling, and implementing energy and ancillary service transactions, such as but not limited to Bilateral Transactions, by DERs. In a further embodiment, the invention may also facilitate a means for registering and approving D-Tags. In either embodiment, a D-Tag can be created comprising any number of data elements, such as but not necessarily limited to, point of receipt, point of delivery, aggregation, distribution path, transmission path, services offered, constraint points, and ownership. The invention may also consider operating constraints, such as but not necessarily limited to, Power Resource Max/Min capability or Ramp Rate limits, as well as distribution grid constraints, including but not limited to element ratings, voltage limits, current limits, and allowable phase unbalance limits.

In at least one embodiment, this disclosure is directed to a computer program for use with a graphics display device, the computer program comprising computer usable medium having computer readable program code means embodied in such medium for facilitating the systems and methods described herein, more specifically computer program code for the input of data, calculation, organization, and reporting of market and bilateral transactions, D-Tag data, bids and offers if any, and DSO dispatch schedules as well as communication of such schedules.

The invention may take the form of a system for the registration, qualification and approval, scheduling, and usage of discrete elements of retail power, configured to:

Receive Asset input data comprised of asset type (load, distributed generation, storage, Electric Vehicle Charger, etc.), technology, control (ON/OFF, raise/lower, set point, etc.), metering (usage, generation), rating, ramp up/down capability where relevant, notification/time delay, rise time, maximum and minimum operating limits, intended services (offer of energy and regulation services), etc.

Validate input data against the asset's capabilities and participant's contractual agreement for the intended services

Package Asset input data together for a particular asset into a registration data file,

Communicate registration data file to an approval entity,

Record the decision of an approval entity,

Submission by Participant of transaction schedule for approved services

Validate input data against the participant's contractual agreement for the intended services and grid conditions to accommodate the transaction

Create Schedules for provision or consumption of energy, provision of grid services, voltage settings, etc.

Format dispatch schedule information for a particular use, and

Send dispatch schedules to impacted systems and the participant

The details of one or more aspects of the disclosure are set forth in the accompanying drawings and the description below. Other features, objects, and advantages will be apparent from the description and drawings that are summarized in the claims.

### BRIEF DESCRIPTION OF DRAWINGS

FIG. 1 is a diagram illustrating a particular embodiment of the overall inventive method.

FIG. 2A is a diagram illustrating a particular embodiment of registration and qualification process steps.

FIG. 2B is a diagram illustrating a particular errlbodiment of registration and qualification process steps.

FIG. 3A is a diagram illustrating a particular embodiment of DSO scheduling and dispatch process steps.

FIG. 3B is a diagram illustrating a particular embodiment of DSO scheduling and dispatch process steps.

FIG. 4 is a diagram illustrating a particularembodiment of Bilateral Transaction process steps.

### DETAILED DESCRIPTION OF THE INVENTION

While this invention may be embodied in many forms, there are specific embodiments of the invention described in detail herein. This description is an exemplification of the principles of the invention and is not intended to limit the invention to the particular embodiments illustrated.

In general, this disclosure is directed toward a system for cataloging the discrete elements of retail power and use of the same facilitated by the use of D-Tags. Using the techniques of this disclosure, owners and/or operators of demand-side assets (e.g., Prosumers, Micro Grids, DR Aggregators, DER Aggregators, Energy Service Providers, etc.), Purchasing Selling Entitles (PSEs), DSOs, power system operators, transmission providers, balancing authorities, energy traders and other energy industry members, may be active participants and decision makers in the information process provided within D-Tags. In some embodiments, the inventive method will maintain a complete or partial log of actions and transactions for later recall and review. Whether the participant's interest is financial, environmental or the reliable operation of the bulk electric system, the system and methods of cataloging and communicating distribution asset information and distribution dispatch schedules for conventional generation, storage, and various, dispatchable demand-side generation and storage resources is a technology enabler for these parties to plan for, as well as adjust in real-time, to manage the transactions between these resources in a reliable and economically beneficial manner.

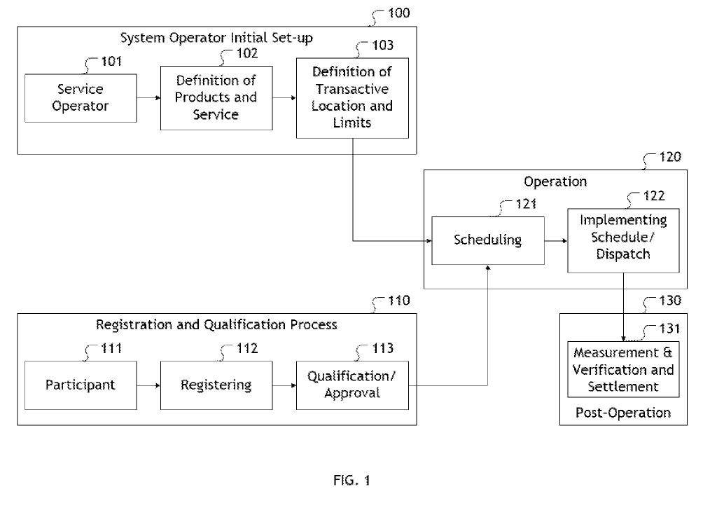

Referring to FIG. 1 and in general, this disclosure is directed toward setting up the system and registering data for qualification and approval, 100, 110, in order to utilize the data of such registered and approved assets for operation (scheduling and dispatch), 120, and Post Operation (Measurement & Verification and Settlement), 130. In one particular embodiment, the process may begin with a system operator initially setting up the system 100. In other embodiments, the registration and qualification process 110 may occur prior to or in tandem with the system operation initial set-up 100. Within the system operator initial set up 100, a service operator 101 defines products and services 102. The service operator 100 then defines transactive location and limits within their service area. These decisions and definitions 102 and 103 are then utilized within the operation process 120 and taken into account while scheduling 121 assets to meet demand. Within the registration and qualification process, 110, a participant 111 performs registration 112 by providing information through any means known in the art, to a reviewing entity 113. The reviewing entity 113 may be, although does not necessarily has to be, a system operator 100. The reviewing entity 113 then reviews the registration information 112. for qualification and approval 113. Approved registration data 113 is then utilized within the operation process 120 and taken into account while scheduling 121 assets to meet demand.

Within the operation process 120, inputs from the system operator initial set-up 100 and registration and qualification process 110 are utilized to schedule assets and services 121 to facilitate market or bilateral transactions. Schedules are then implemented and dispatch occurs 122 after scheduling 121 is determined. Measurement and verification of results 131 occur post operation 130 in order to provide transaction reporting capabilities for settlement and dispute resolution. In embodiments where the method is implemented as computer software utilized on a computer, such transactions can be accomplished in large scale and in an automated fashion. Moreover, utilizing encryption enabling software and multi-factored credential user authentication, the method can be implemented in a highly secure fashion.

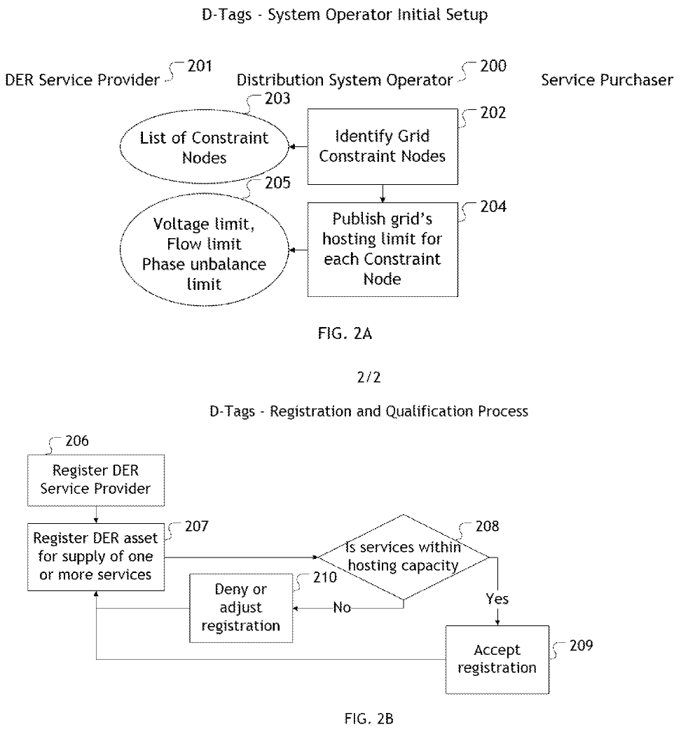

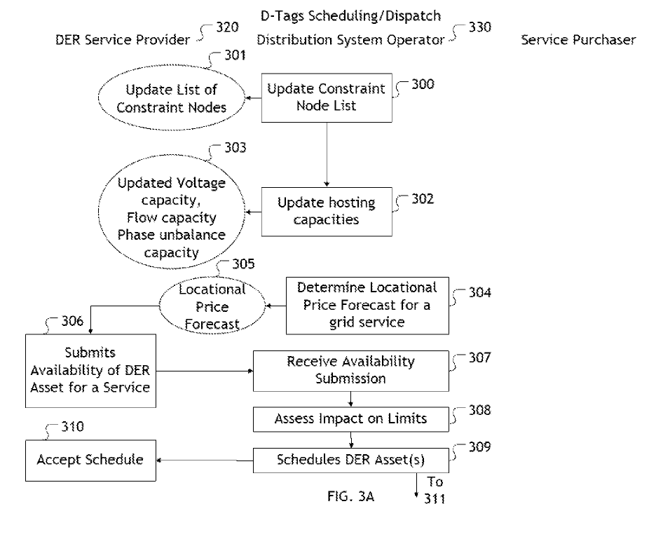

Turning now to FIG. 2A and FIG. 2B, in one embodiment, the system operator initial setup process begins with the introduction of data inputs. The Distribution System Operator 200 identifies Grid Constraint Nodes 202 and publishes these constraints nodes 203. The Distribution System Operator 200 will also identify available capacity for different type of product/service for each Constraint Node 204 and publish these capacities 205. A participant 201, such as owners, and/or operators of demand-side assets for example, may submit a request 206 to become a participant within the described system and methods. Once Participant 201 is registered 206, it can register a DER asset to supply one or more services 207. Such request 207 may be comprised of any number of data elements, such as but not necessarily limited to, point of receipt, point of delivery, asset capacity, characteristics, asset type, technology, control, metering, rating, ramp up/down capability, notification/time delay, rise time, maximum and minimum operating limits, intended services available/desired, as well as certain ownership information. A system operator 200 reviews submitted requests to verify qualifications of the asset seeking registration as a participating asset. The qualifications required by such system operator can vary according to that system operator's desires. In some embodiments, a system operator 200 would review the submitted request 207 for certain reliability qualifications including making a determination if the services are hosed within the system operator's capacity 208. Based on system operator 200, the DER asset registration 207 is either accepted 209 or denied 210. In some embodiments, a system operator 200 may also validate a participant's 201 input data 207 against the asset's capabilities and participant's contractual agreement for the intended services.

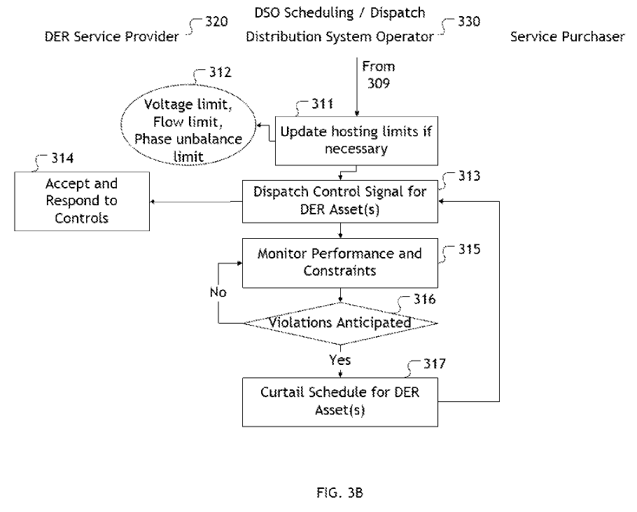

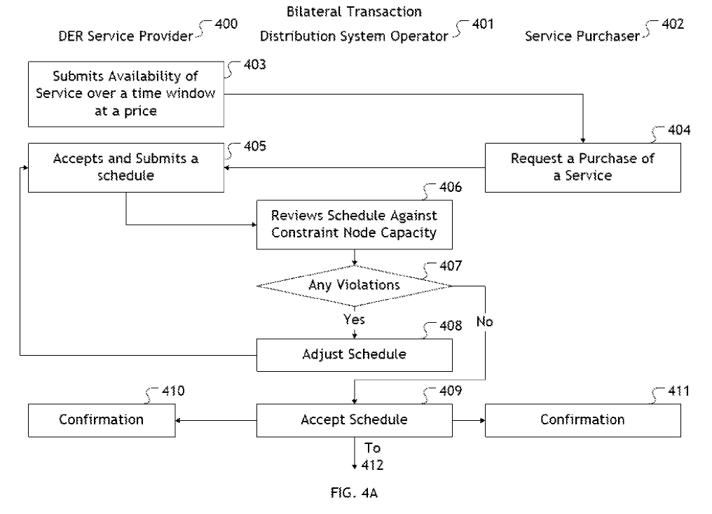

Referring now to FIG. 3A and FIG. 3B, which illustrate a particular embodiment of daily operation for D-Tags scheduling and dispatch of various distribution services. Occasionally, the system operator 330, such as a DSO, may update Constraint Node 300; developing and publishing an updated list of constrained nodes 301. The system operator 330 may also update the grid's hosting capacity of each product/service for each constrained node 302 and update the published list of the capacity of products/services at each constraint node 303. During daily operation, a system operator 330 may Determine Locational Price Forecast for a grid service 304 and then publish or transmit to a participant 320, such as although not necessarily limited to a DER Service Provider, the Locational Price Forecast 305. A DER Service Provider 320 can then consider the transmitted locational price data 305 in order to create an availability submission data packet 306. In one particular embodiment, the DER Service Provider 320 submits the availability of DER Asset for a Smice 306 using a D-Tag, which may include but are not necessarily limited to specific start and stop time (or time window) data or capacity amount of the DER Service Provider's 201 asset over such time. Preferred embodiments require that such start time to be in the future. The system operator 330 receives availability submission 307 from a participant 320 and, after assessing the impact on the various limits 308, schedules the DER Asset(s) 309 and transmit the schedule to DER Service Provider 200, who accepts the schedules 310 and prepares the asset to deliver the scheduled grid service. In some embodiments, the system operator may validate the participant's 320 submission of availability of DER Asset for a Service 306 against the participant's contractual agreement for the intended services and grid conditions in order to accommodate the transaction.

Based upon the DER Asset Schedule 309, the hosting limits may be updated if necessary 311 by the system operator 330 and the updated limits for each service may be published or transmitted 312 to a DER Service Provider 320. During real time operation, the DER Asset Schedules 309 are converted to Dispatch Control Signals 313 for each DER Asset(s) and transmitted to DER service provider's 320 DER Asset which accept and Response to Controls 314. Also during real time operation, the system operator 330 will Monitor Performance and System Constraints 315 and if a Violation Anticipated 316, it will Curtail Schedules for DER Asset(s) 317 pro-rata or based upon any criteria deemed preferable, such as although not limited to, cost and FIFO ordering and use the new schedule for Dispatch Control Signal for DER Asset 313. If no Violation Anticipated 316, DSO will continue Monitor Performance and Constraints 315.

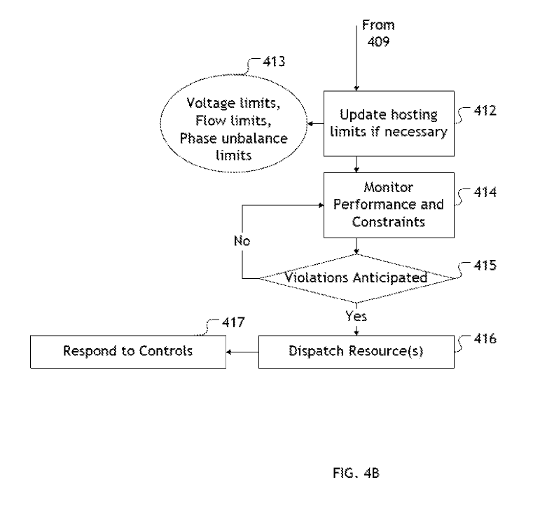

Referring now to FIG. 4A and 4B, in one particular embodiment, the inventive process may facilitate, after asset registration is accepted, a bilateral transaction wherein a participant 400, such as but not necessarily limited to a DER service provider, is able to submit the availability of service 403. In one particular embodiment, such availability submission may include a specific start and stop time, or time window, as well as a price for dispatch of the participant's 400 asset over such time. The participant's 400 submission 403 is made available to Service Purchasers 402 through any interface known in the art, and in preferred embodiments, such submission 403 presentation is accomplished under an interface operated under a system operator 401. A service purchaser 402 may then Request a purchase of a service 404 from the participant 400. The participant 400 may then accept and submit 405 a schedule to the system operator 401. The system operator 401 may then review the schedule against constraint node capacity 406 and makes a determination of whether any violations exist 407. If violations do exist, the system operator 401 may suggest schedule adjustments 408 and reject the submission back to the participant 400. If there are no violations, the system operator 401 may accept the schedule 409 and send confirmation 410, 411 to the participant 400 and the service purchaser 402. The system operator 401 may then update the hosting capacities 412, if necessary, for voltage, flow and phase unbalance capacities and make the update limits available to participant 413. In real time, the system operator 401 then monitors performance and constraints 414 to make a determination if any violations are anticipated 415. If no violations, monitoring 414 continues. If violations are anticipated, the system operator 401 dispatches the resources 416 to remove the violation. The participant devices 400 then respond to control commands.

Due to the simplified nature of the required inputs and participant relationships, the invention can facilitate DSO/DSP management of a large volume of transactions effectively and in a timely manner. In some embodiments, the described process can also occur automatically and without undue human interaction, therefor permitting automation and speed that are necessary to assist a system operator in processing thousands of transactions a minute. This can be similarly be accurate in a preferred embodiment wherein the proposed system and methods are facilitated through use of computer means.

After the Fact, during post operation, the system operator/DSO 401 and Participant 400 may go through agreed on measurement & verification process and settlement in order to provide transaction reporting capabilities for settlement and dispute resolution.

In some particular embodiments wherein the invention is comprised of computer software, the invention may further utilize encryption enabling software, such as but not necessarily limited to digital certificates, to secure access to the system and encrypt communications sent to and from components within the inventive system and method. Using any number of methods known in the art, the invention may require and validate for the presence of specific encryption enabling software as a login credential. In preferred embodiments, such encryption enabling software is associated on a one-to-one basis with a particular user account. Login to the system of such embodiment would be denied unless the system validates, using any method known in the art, that a user's request to access the system includes the correctly corresponding login credentials comprising of username, password, and encryption enabling software, among others, associated with a particular predefined user account. Moreover, in other embodiments, encryption enabling software may be utilized to encrypt data communications within the invention, such as but not necessarily limited to, the submission of availability submission data packet 304 from a participant 300 source to a system operator 301 recipient, or the submission of a registration request 200 from a participant 202 source to a system operator 203 recipient.

Using any method known in the art, encryption enabling software can be incorporated into the invention such that all messages and data transmissions are encrypted upon sending and then decrypted upon receipt. Such encryption can be accomplished using any known means available in the art. As a non-limiting example, in certain embodiments, the invention may comprise of computer software located on a participant 202, 300, 400 device, which may act as data publishing sources, or from any other data publishing source, such as although not necessarily limited to, a computer, tablet, or mobile device utilized to send messages and data transmissions to facilitate the system and methods herein described. Such data publishing sources and devices can be set up with encryption enabling software, such as but not necessarily limited to digital certificates, to facilitate the encryption of communication sent between a data publishing source and data reception point, such as although not necessarily limited to a computer, tablet or mobile device utilized to receive messages and data transmissions to facilitate the system and methods herein described. Messages/communication 991 sent between a data publishing source and a data reception point may be encrypted during transmission using a data publishing source's encryption enabling software and subsequently decrypted at a data reception point by encryption enabling software. Such pre-incorporation of encryption enabling software by both the sending and recipient components ensures that any intercepted communications cannot be read, thus raising the confidence level of transactions occurring within the system as a whole.

1. A system for the registration, qualification and approval, scheduling, and usage of discrete elements of retail power, configured to:
Receive asset input data,
Validate input data against the asset's capabilities and participant's contractual agreement for the intended services,
Package Asset input data together for a particular asset into a registration data file,
Communicate registration data file to an approval entity,
Record the decision of an approval entity,
Submission by Participant of transaction schedule for approved services,
Validate transaction schedule data against the participant's contractual agreement for the intended services and grid conditions to accommodate the transaction,
Create Schedules for provision or consumption of energy, provision of grid services, voltage settings, etc.,
Format dispatch schedule information for a particular use, and
Send dispatch schedules to impacted systems and the participant.

2. The method of claim 1, wherein asset input data may comprise asset type, technology, control, metering, rating, ramp up/down capability where relevant, notification/time delay, rise time, maximum and minimum operating limits, and intended services.

3. The method of claim 1, wherein encryption enabling software is utilized to protect messages.

4. The method of claim 1, wherein a complete or partial log of actions and transactions is maintained for later review.

5. The method of claim 1, wherein a system operator utilizes a discrete data packet to individually identify a particular participant's asset capacity and schedule.
